(19) United States
(12) Patent Application Publication
(10) Pub. No.: US 2022/0239591 A1
(43) Pub. Date: Jul. 28, 2022

(54) COORDINATION OF SDN UNDERLAY AND OVERLAY FOR DETERMINISTIC TRAFFIC

(71) Applicant: Cisco Technology, Inc., San Jose, CA (US)

(72) Inventors: Robert E. Barton, Richmond (CA); Jerome Henry, Pittsboro, NC (US); Maik Guenter Seewald, Nuernberg (DE); Padavala M. Rao, Bangalore (IN)

(21) Appl. No.: 17/159,353

(22) Filed: Jan. 27, 2021

(51) Int. Cl. H04L 12/721; H04L 12/26; H04L 12/741; H04L 12/46; H04L 12/707

(52) U.S. Cl. CPC H04L 45/70; H04L 43/08; H04L 45/22; H04L 12/4641; H04L 45/74

(57) ABSTRACT

In one embodiment, a software-defined networking controller obtains endpoint data regarding an endpoint in a network. The controller identifies, based on the endpoint data, deterministic requirements of the endpoint. The controller obtains performance characteristics of the network. The controller configures, based on the performance characteristics of the network, an overlay path in the network connecting the endpoint to a destination and satisfies the deterministic requirements of the endpoint.

### TECHNICAL FIELD

The present disclosure relates generally to computer networks, and, more particularly, to the coordination of Software-Defined Networking (SDN) underlay and overlay for deterministic traffic.

### BACKGROUND

Software defined networking (SDN) represents an evolution of computer networks away from a decentralized architecture to one of centralized, software-based control. More specifically, in traditional computer networks, the control plane (e.g., selection of the routing path) and the data plane (e.g., forwarding packets along the selected path) are intertwined, with control plane decisions being made in a decentralized manner via signaling between the networking devices. In contrast, control plane decisions in an SDN-based network architecture are made by a centralized controller and pushed to the networking devices, as needed. Typically, SDN-based networks are comprised of both an underlay network and an overlay network.

One potential use for SDN-based networks is in Internet of Things (IoT) deployments, as centralized policy orchestration allows the creation of an overlay architecture that not only segments sensitive parts of the network, but also allows for the creation of secure architectures over the network fabric (e.g., to meet certain security requirements). However, SDN-based networks today give little consideration to any timing requirements for time sensitive traffic as it traverses an SDN overlay. This is due to a lack of coordination between the underlay control plane and the overlay data forwarding plane. Consequently, latency in the overlay could lead to traffic packets being delivered outside of their required delivery windows, which could affect the operation of a control loop in the network, lead to decisions being made based on stale data, etc.

### BRIEF DESCRIPTION OF THE DRAWINGS

The embodiments herein may be better understood by referring to the following description in conjunction with the accompanying drawings in which like reference numerals indicate identically or functionally similar elements, of which:

FIG. 1 illustrate an example Internet of Things (IoT) network;

FIG. 2 illustrates an example network device/node;

FIG. 3 illustrates an example software defined networking (SDN) network;

FIG. 4 illustrates an example communication diagram;

FIG. 5 illustrates an example of the SDN network of FIG. 3 showing various performance characteristics;

FIG. 6 illustrates an example of a deterministic path being established in the SDN network of FIG. 3; and

FIG. 7 illustrates an example simplified procedure for the coordination of the overlay and underlay of an SDN for deterministic traffic.

### DESCRIPTION OF EXAMPLE EMBODIMENTS

Overview

According to one or more embodiments of the disclosure, a software-defined networking controller obtains endpoint data regarding an endpoint in a network. The controller identifies, based on the endpoint data, deterministic requirements of the endpoint. The controller obtains performance characteristics of the network. The controller configures, based on the performance characteristics of the network, an overlay path in the network connecting the endpoint to a destination and satisfies the deterministic requirements of the endpoint.

### DESCRIPTION

A computer network is a geographically distributed collection of nodes interconnected by communication links and segments for transporting data between end nodes, such as personal computers and workstations, or other devices, such as sensors, etc. Many types of networks are available, ranging from local area networks (LANs) to wide area networks (WANs). LANs typically connect the nodes over dedicated private communications links located in the same general physical location, such as a building or campus. WANs, on the other hand, typically connect geographically dispersed nodes over long-distance communications links, such as common carrier telephone lines, optical lightpaths, synchronous optical networks (SONET), synchronous digital hierarchy (SDH) links, or Powerline Communications (PLC), and others. Other types of networks, such as field area networks (FANs), neighborhood area networks (NANs), personal area networks (PANs), etc. may also make up the components of any given computer network.

In various embodiments, computer networks may include an Internet of Things network. Loosely, the term “Internet of Things” or “IoT” (or “Internet of Everything” or “IoE”) refers to uniquely identifiable objects (things) and their virtual representations in a network-based architecture. In particular, the IoT involves the ability to connect more than just computers and communications devices, but rather the ability to connect “objects” in general, such as lights, appliances, vehicles, heating, ventilating, and air-conditioning (HVAC), windows and window shades and blinds, doors, locks, etc. The “Internet of Things” thus generally refers to the interconnection of objects (e.g., smart objects), such as sensors and actuators, over a computer network (e.g., via IP), which may be the public Internet or a private network.

Often, IoT networks operate within a shared-media mesh networks, such as wireless or PLC networks, etc., and are often on what is referred to as Low-Power and Lossy Networks (LLNs), which are a class of network in which both the routers and their interconnect are constrained. That is, LLN devices/routers typically operate with constraints, e.g., processing power, memory, and/or energy (battery), and their interconnects are characterized by, illustratively, high loss rates, low data rates, and/or instability. IoT networks are comprised of anything from a few dozen to thousands or even millions of devices, and support point-to-point traffic (between devices inside the network), point-to-multipoint traffic (from a central control point such as a root node to a subset of devices inside the network), and multipoint-to-point traffic (from devices inside the network towards a central control point).

Edge computing, also sometimes referred to as “fog” computing, is a distributed approach of cloud implementation that acts as an intermediate layer from local networks (e.g., IoT networks) to the cloud (e.g., centralized and/or shared resources, as will be understood by those skilled in the art). That is, generally, edge computing entails using devices at the network edge to provide application services, including computation, networking, and storage, to the local nodes in the network, in contrast to cloud-based approaches that rely on remote data centers/cloud environments for the services. To this end, an edge node is a functional node that is deployed close to IoT endpoints to provide computing, storage, and networking resources and services. Multiple edge nodes organized or configured together form an edge compute system, to implement a particular solution. Edge nodes and edge systems can have the same or complementary capabilities, in various implementations. That is, each individual edge node does not have to implement the entire spectrum of capabilities. Instead, the edge capabilities may be distributed across multiple edge nodes and systems, which may collaborate to help each other to provide the desired services. In other words, an edge system can include any number of virtualized services and/or data stores that are spread across the distributed edge nodes. This may include a master-slave configuration, publish-subscribe configuration, or peer-to-peer configuration.

Low power and Lossy Networks (LLNs), e.g., certain sensor networks, may be used in a myriad of applications such as for “Smart Grid” and “Smart Cities.” A number of challenges in LLNs have been presented, such as:

1) Links are generally lossy, such that a Packet Delivery Rate/Ratio (PDR) can dramatically vary due to various sources of interferences, e.g., considerably affecting the bit error rate (BER);

2) Links are generally low bandwidth, such that control plane traffic must generally be bounded and negligible compared to the low rate data traffic;

3) There are a number of use cases that require specifying a set of link and node metrics, some of them being dynamic, thus requiring specific smoothing functions to avoid routing instability, considerably draining bandwidth and energy;

4) Constraint-routing may be required by some applications, e.g., to establish routing paths that will avoid non-encrypted links, nodes running low on energy, etc.;

5) Scale of the networks may become very large, e.g., on the order of several thousands to millions of nodes; and

6) Nodes may be constrained with a low memory, a reduced processing capability, a low power supply (e.g., battery).

In other words, LLNs are a class of network in which both the routers and their interconnect are constrained: LLN routers typically operate with constraints, e.g., processing power, memory, and/or energy (battery), and their interconnects are characterized by, illustratively, high loss rates, low data rates, and/or instability. LLNs are comprised of anything from a few dozen and up to thousands or even millions of LLN routers, and support point-to-point traffic (between devices inside the LLN), point-to-multipoint traffic (from a central control point to a subset of devices inside the LLN) and multipoint-to-point traffic (from devices inside the LLN towards a central control point).

An example implementation of LLNs is an “Internet of Things” network. Loosely, the term “Internet of Things” or “IoT” may be used by those in the art to refer to uniquely identifiable objects (things) and their virtual representations in a network-based architecture. In particular, the next frontier in the evolution of the Internet is the ability to connect more than just computers and communications devices, but rather the ability to connect “objects” in general, such as lights, appliances, vehicles, HVAC (heating, ventilating, and air-conditioning), windows and window shades and blinds, doors, locks, etc. The “Internet of Things” thus generally refers to the interconnection of objects (e.g., smart objects), such as sensors and actuators, over a computer network (e.g., IP), which may be the Public Internet or a private network. Such devices have been used in the industry for decades, usually in the form of non-IP or proprietary protocols that are connected to IP networks by way of protocol translation gateways. With the emergence of a myriad of applications, such as the smart grid advanced metering infrastructure (AMI), smart cities, and building and industrial automation, and cars (e.g., that can interconnect millions of objects for sensing things like power quality, tire pressure, and temperature and that can actuate engines and lights), it has been of the utmost importance to extend the IP protocol suite for these networks.

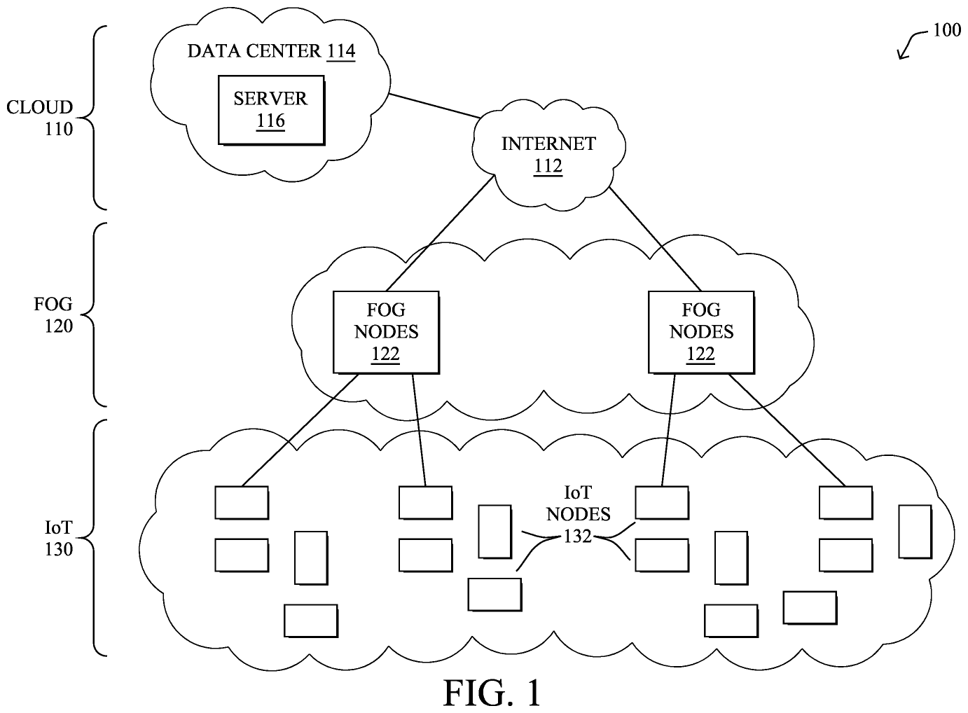

FIG. 1 is a schematic block diagram of an example simplified IoT network 100 illustratively comprising nodes/devices at various levels of the network, interconnected by various methods of communication. For instance, the links may be wired links or shared media (e.g., wireless links, PLC links, etc.) where certain nodes, such as, e.g., routers, sensors, computers, etc., may be in communication with other devices, e.g., based on connectivity, distance, signal strength, current operational status, location, etc.

Specifically, as shown in the example IoT network 100, three illustrative layers are shown, namely cloud layer 110, edge layer 120, and IoT device layer 130. Illustratively, the cloud layer 110 may comprise general connectivity via the Internet 112, and may contain one or more datacenters 114 with one or more centralized servers 116 or other devices, as will be appreciated by those skilled in the art. Within the edge layer 120, various edge devices 122 may perform various data processing functions locally, as opposed to datacenter/cloud-based servers or on the endpoint IoT nodes 132 themselves of IoT device layer 130. For example, edge devices 122 may include edge routers and/or other networking devices that provide connectivity between cloud layer 110 and IoT device layer 130. Data packets (e.g., traffic and/or messages sent between the devices/nodes) may be exchanged among the nodes/devices of the computer network 100 using predefined network communication protocols such as certain known wired protocols, wireless protocols, PLC protocols, or other shared-media protocols where appropriate. In this context, a protocol consists of a set of rules defining how the nodes interact with each other.

Those skilled in the art will understand that any number of nodes, devices, links, etc. may be used in the computer network, and that the view shown herein is for simplicity. Also, those skilled in the art will further understand that while the network is shown in a certain orientation, the network 100 is merely an example illustration that is not meant to limit the disclosure.

Data packets (e.g., traffic and/or messages) may be exchanged among the nodes/devices of the computer network 100 using predefined network communication protocols such as certain known wired protocols, wireless protocols (e.g., IEEE Std. 802.15.4, Wi-Fi, Bluetooth®, DECT-Ultra Low Energy, LoRa, etc..), PLC protocols, or other shared-media protocols where appropriate. In this context, a protocol consists of a set of rules defining how the nodes interact with each other.

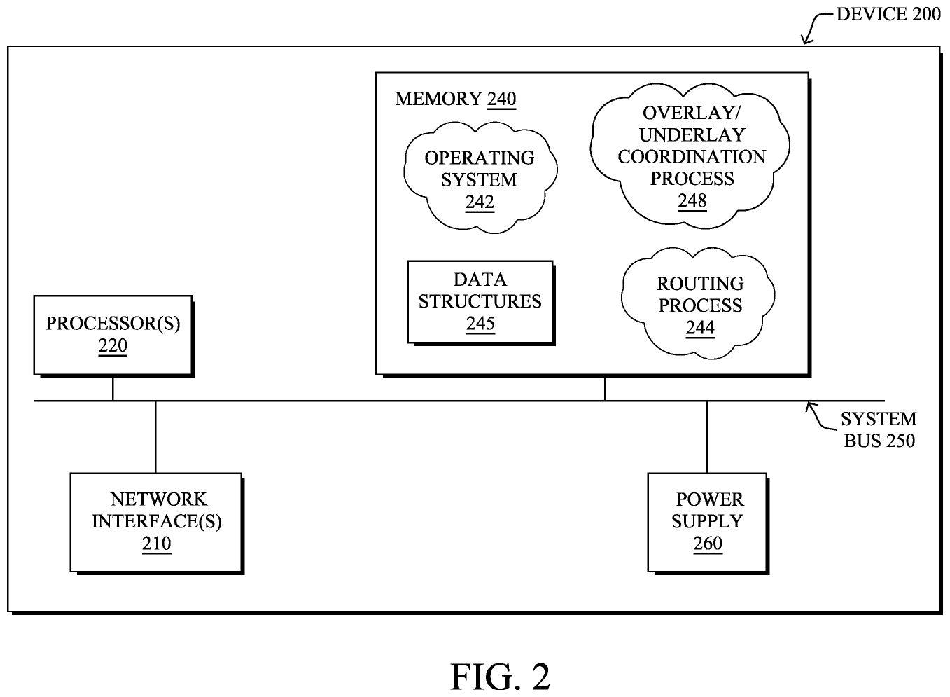

FIG. 2 is a schematic block diagram of an example node/device 200 that may be used with one or more embodiments described herein, e.g., as any of the nodes or devices shown in FIG. 1 above or described in further detail below. The device 200 may comprise one or more network interfaces 210 (e.g., wired, wireless, PLC, etc.), at least one processor 220, and a memory 240 interconnected by a system bus 250, as well as a power supply 260 (e.g., battery, plug-in, etc.).

Network interface(s) 210 include the mechanical, electrical, and signaling circuitry for communicating data over links coupled to the network. The network interfaces 210 may be configured to transmit and/or receive data using a variety of different communication protocols, such as TCP/IP, UDP, etc. Note that the device 200 may have multiple different types of network connections, e.g., wireless and wired/physical connections, and that the view herein is merely for illustration. Also, while the network interface 210 is shown separately from power supply 260, for PLC the network interface 210 may communicate through the power supply 260, or may be an integral component of the power supply. In some specific configurations the PLC signal may be coupled to the power line feeding into the power supply.

The memory 240 comprises a plurality of storage locations that are addressable by the processor 220 and the network interfaces 210 for storing software programs and data structures associated with the embodiments described herein. The processor 220 may comprise hardware elements or hardware logic adapted to execute the software programs and manipulate the data structures 245. An operating system 242, portions of which are typically resident in memory 240 and executed by the processor, functionally organizes the device by, among other things, invoking operations in support of software processes and/or services executing on the device. These software processes/services may comprise a routing process 244 and/or an overlay/underlay coordination process 248, as described herein.

It will be apparent to those skilled in the art that other processor and memory types, including various computer-readable media, may be used to store and execute program instructions pertaining to the techniques described herein. Also, while the description illustrates various processes, it is expressly contemplated that various processes may be embodied as modules configured to operate in accordance with the techniques herein (e.g., according to the functionality of a similar process). Further, while the processes have been shown separately, those skilled in the art will appreciate that processes may be routines or modules within other processes.

Routing process 244 includes computer executable instructions executed by processor 220 to perform functions provided by one or more routing protocols, such as the Interior Gateway Protocol (IGP) (e.g., Open Shortest Path First, “OSPF,” and Intermediate-System-to-Intermediate-System, “IS-IS”), the Border Gateway Protocol (BGP), etc., as will be understood by those skilled in the art. These functions may be configured to manage a forwarding information database including, e.g., data used to make forwarding decisions. In particular, changes in the network topology may be communicated among devices 200 using routing protocols, such as the conventional OSPF and IS-IS link-state protocols (e.g., to “converge” to an identical view of the network topology).

Notably, routing process 244 may also perform functions related to virtual routing protocols, such as maintaining VRF instance, or tunneling protocols, such as for MPLS, generalized MPLS (GMPLS), etc., each as will be understood by those skilled in the art. Also, EVPN, e.g., as described in the IETF Internet Draft entitled “BGP MPLS Based Ethernet VPN”<draft-ietf-12vpn-evpn>, introduce a solution for multipoint L2VPN services, with advanced multi-homing capabilities, using BGP for distributing customer/client media access control (MAC) address reach-ability information over the core MPLS/IP network.

Another example protocol that routing process 244 may implement, particularly in the case of LLN mesh networks, is the Routing Protocol for Low Power and Lossy (RPL), which provides a mechanism that supports multipoint-to-point (MP2P) traffic from devices inside the LLN towards a central control point (e.g., LLN Border Routers (LBRs) or “root nodes/devices” generally), as well as point-to-multipoint (P2MP) traffic from the central control point to the devices inside the LLN (and also point-to-point, or “P2P” traffic). RPL (pronounced “ripple”) may generally be described as a distance vector routing protocol that builds a Directed Acyclic Graph (DAG) for use in routing traffic/packets 140, in addition to defining a set of features to bound the control traffic, support repair, etc. Notably, as may be appreciated by those skilled in the art, RPL also supports the concept of Multi-Topology-Routing (MTR), whereby multiple DAGs can be built to carry traffic according to individual requirements.

According to various embodiments, node/device 200 may communicate deterministically within a network. Example standards for deterministic networking include, but are not limited to, Institute of Electrical and Electronics Engineers (IEEE) Time Sensitive Networking (TSN) standards such as 802.1Q, 802.1AB, 802.1AS, 802.1AX, 802.1BA, 802.1CB, and 802.1CM. Likewise, the Internet Engineering Task Force (IETF) has established a deterministic network (DetNet) working group to define a common deterministic architecture for Layer 2 and Layer 3. Further standards for deterministic networking also include OPC Unified Architecture (UA) from the OPC Foundation, as well as the International Electrotechnical Commission (IEC) 61850-90-13 and MT-9 standards. As would be appreciated, the deterministic networking standards listed above are exemplary only and the techniques herein can be used with any number of different deterministic networking protocols.

In general, deterministic networking represents recent efforts to extend networking technologies to industrial settings. Indeed, industrial networking requires having predictable communications between devices. For example, consider a control loop in which a controller controls an actuator, based on a reading from a sensor. In such a case, a key requirement of the network may be the guarantee of packets being delivered within a bounded time. This translates into the following characteristics needed by a typical deterministic network:
High delivery ratio (e.g., a loss rate of 10⁻⁵ to 10⁻⁹, depending on the application)
Fixed latency
Jitter close to zero (e.g., on the order of microseconds)

A limited degree of control can be achieved with QoS tagging and shaping/admission control. For time sensitive flows, though, latency and jitter can only be fully controlled with the effective scheduling of every transmission at every hop. In turn, the delivery ratio can be optimized by applying 1+1 packet redundancy, such as by using High-availability Seamless Redundancy (HSR), Parallel Redundancy Protocol (PRP), or the like, with all possible forms of diversity, in space, time, frequency, code (e.g., in CDMA), hardware (links and routers), and software (implementations).

Deterministic Ethernet and deterministic wireless generally utilize a communication scheduling mechanism (e.g., as computed by a supervisory device) that requires the internal clocks of the nodes/devices along a network path to be synchronized. To do so, a time synchronization protocol, such as the Network Time Protocol (NTP) or Precision Time Protocol (PTP) can be used to effect clock synchronization among the network devices. The degree of clock precision among the devices often needs to be within microseconds or less. For instance, in the case of TSN, a centralized network controller (CNC) may define the schedules on which all TSN frames are transmitted. Likewise, endpoints may signal their needs for determinism to a centralized user configuration (CUC) that operates in conjunction with the CNC, to schedule communications for that endpoint.

The forwarding of each packet is then regulated by a deterministic communication schedule that specifies when the packet has to be transmitted to the wire or radio. This is done for each node/device along the network path. The specific time period is called a time slot. A supervisory device, sometimes referred to as the “orchestrator,” usually performs the computation of this path and the associated timetable. Such an approach is akin to a PCE in MPLS networks, in order to compute Traffic Engineering Label Switched Paths, with the major difference being that a time schedule is computed instead of simply a constrained shortest path (e.g., the path in a deterministic network having both spatial and temporal aspects). When the supervisory device completes computation of the deterministic communication schedule, it may then download the path and the timetable to each of the devices participating in the forwarding. In turn, these nodes will then begin receiving and sending packets according to the computed schedule.

As noted above, software-defined networking (SDN) represents a shift in computer networking that seeks to separate the network control plane from that of the forwarding plane. More specifically, rather than relying on hardware to make routing decisions, SDN allows these decisions to be centralized with an SDN controller. Accordingly, the SDN controller can make policy-based routing decisions that would normally not be possible with a more traditional networking approach. A key aspect of SDN is the use of an overlay network, which exists as a virtual network layer on top of the physical/underlay network, itself. Typically, this is done by establishing, via software, a virtual tunnel between an endpoint and its destination. Example protocols for establishing an overlay network include, but are not limited to, virtual extensible LAN (VxLAN), virtual private networks (VPNs), IP multicast, and the like.

As noted above, SDN is particularly of interest in IoT networks, as the centralized policy orchestration in SDN allows the creation of an overlay architecture that not only segments sensitive parts of the network, but also allows for the creation of secure architectures over the network fabric (e.g., to meet certain security requirements). However, SDN-based networks today give little consideration to the deterministic requirements of an endpoint as its traffic traverses an SDN overlay. This is due to a lack of coordination between the underlay control plane and the overlay data forwarding plane. For instance, in the case of TSN, the operations of the CNC and CUC are wholly independent from that of the SDN controller. Consequently, latency in the SDN overlay could lead to traffic packets being delivered outside of their required delivery windows, which could affect the operation of a control loop in the network, lead to decisions being made based on stale data, etc.

Coordination of SDN Underlay and Overlay for Deterministic Traffic

The techniques introduced herein allow for an SDN controller to discover the networking intent of an endpoint (e.g., in terms of its latency, jitter, and/or bandwidth requirements), such as whether the traffic of the endpoint requires determinism. In turn, the SDN controller may create an overlay path through the network that satisfies these requirements. In some aspects, a special overlay tag/identifier may be used to mark the traffic associated with the endpoint. This allows the scheduling of the packets to take place at the egress of the physical or virtual device, but can now be based on the overlay tag/identifier that is visible from the underlay.

Illustratively, the techniques described herein may be performed by hardware, software, and/or firmware, such as in accordance with overlay/underlay coordination process 248, which may include computer executable instructions executed by the processor 220 (or independent processor of interfaces 210) to perform functions relating to the techniques described herein, potentially in conjunction with routing process 244.

Specifically, in various embodiments, a software-defined networking controller obtains endpoint data regarding an endpoint in a network. The controller identifies, based on the endpoint data, deterministic requirements of the endpoint. The controller obtains performance characteristics of the network. The controller configures, based on the performance characteristics of the network, an overlay path in the network connecting the endpoint to a destination and satisfies the deterministic requirements of the endpoint.

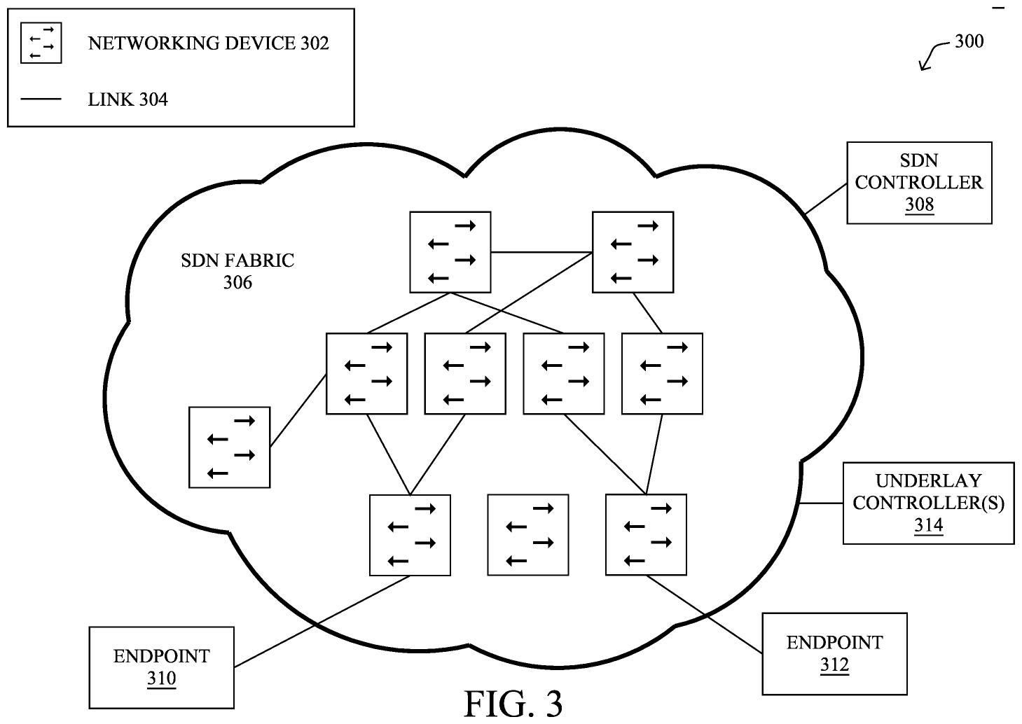

Operationally, FIG. 3 illustrates an example SDN network 300, according to various embodiments. As shown, SDN network 300 may comprise any number of networking devices 302 (e.g., routers, etc.) that are interconnected with one another via links 304. At the overlay level, SDN network 300 may also include an SDN controller 308 that may be connected to networking devices 302, to form and oversee an SDN fabric 306. During operation, SDN controller 308 may compute paths and install them to SDN fabric 306 as overlay tunnels.

Also as shown, at the underlay level, SDN network 300 may also include one or more underlay controller(s) 314 connected to networking devices 302. In general, underlay controller(s) 314 may be responsible for handling the operations of the network underlay, such as generating forwarding schedules and pushing them to networking devices 302. For instance, underlay controller(s) may include a CNC and a CUC, in the case in which the underlay network utilizes TSN for forwarding scheduling. In other words, underlay controller(s) 314 may be responsible for establishing and pushing forwarding schedules to networking devices 302.

For TSN or other deterministic underlay to work in an SDN, the following must be met: 1.) overlay tunnel path must be known or engineered, 2.) egress scheduling on each fabric node for the encapsulated overlay packets, and 3.) quality of service (QoS) synchronization of the underlay with the overlay. According to various embodiments, the techniques herein achieve each of these.

To achieve deterministic latency for an application and its associated traffic, it is necessary to know the end-to-end path requirements for the traffic. This may include, for instance, the jitter, bi-directional (congruent) latency requirements, bandwidth, or the like. Indeed, many TSN applications often involve specialized types of hardware, such as motion controls, protection relays, etc.

According to various embodiments, SDN controller 308, or another device operating in conjunction therewith, may identify the deterministic requirements of an endpoint in network 300. For instance, assume that endpoint 310 is added to the network and is to send deterministic traffic to an endpoint 312. In some embodiments, the deterministic requirements for the traffic between endpoint 310 and endpoint 312 may be entered manually into a policy server, such as a CUC in underlay controller(s) 314 or directly to SDN controller 308.

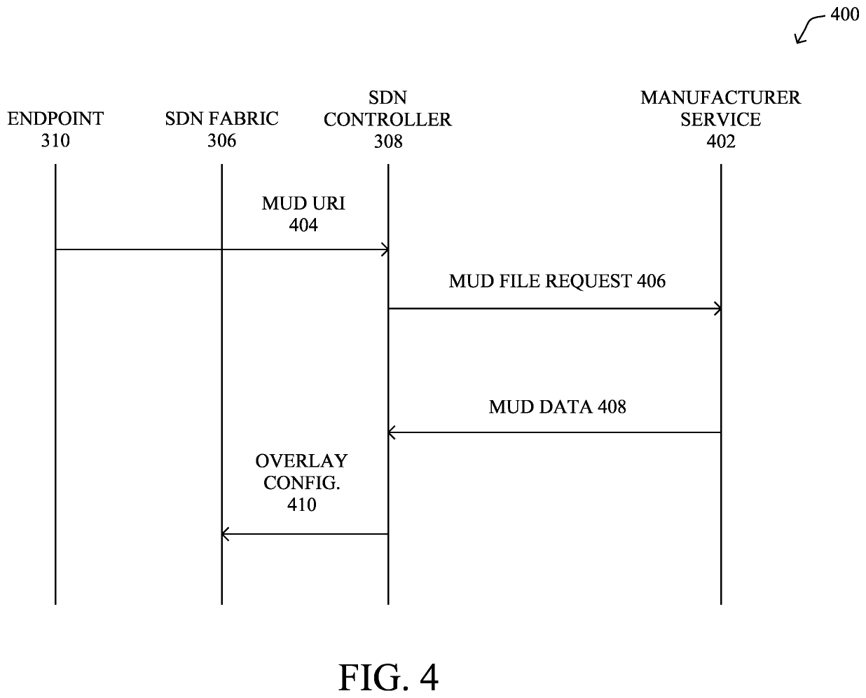

In more advanced embodiments, SDN controller 308 may learn of the deterministic requirements of endpoint 310, automatically. For instance, FIG. 4 illustrates an example communication diagram 400, according to one embodiment. As shown, endpoint 310 may announce itself to be of a particular device type via the Manufacturer Usage Description (MUD) protocol, as specified in the Internet Engineering Task Force (IETF) draft entitled, “Manufacturer Usage Description Specification.” More specifically, endpoint 310 may send a MUD uniform resource indicator (URI) 404 through SDN fabric 306 to SDN controller 308 that indicates the location of a manufacturer service 402 (e.g., the manufacturer of endpoint 310).

In response to receiving MUD URI 404, SDN controller 308 may send a MUD file request 406 to manufacturer service 402 located at the indicated URI. In turn, manufacturer service 402 may return MUD data 408 (e.g., a MUD file) that includes information about endpoint 310 and its traffic requirements. As would be appreciated, MUD files are typically used for network security purposes and do not indicate the traffic requirements of an endpoint. However, in some embodiments, such MUD data 408 may be extended to also indicate the traffic requirements of endpoint 310, such as whether its traffic requires determinism and, if so, the thresholds involved (e.g., a maximum latency value, a maximum bandwidth value, etc.).

As described in greater detail below, SDN controller 308 may then use MUD data 408 to configure the overlay of SDN fabric 306 by pushing overlay configuration 410 to it, such that the overlay meets the requirements of the traffic of endpoint 310.

Note that, in some implementations, SDN controller 308 may receive MUD data 408 from another device or service in the network operating in conjunction with SDN controller 308, in which case the other device or service may be viewed as an extension of SDN controller 308 for purposes of the teachings herein.

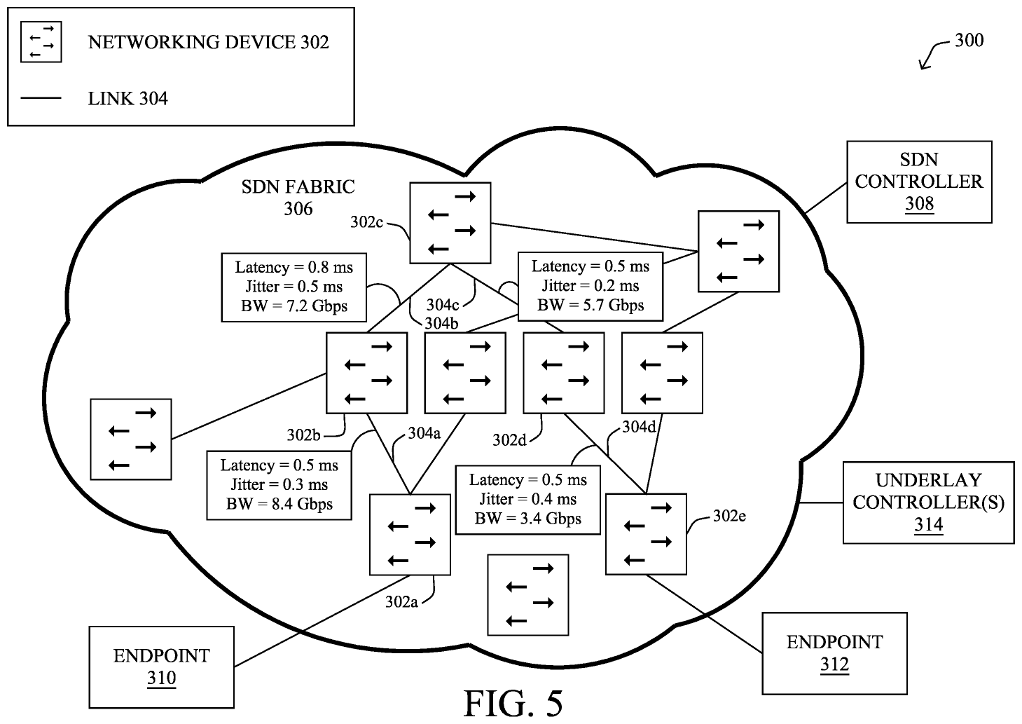

As shown in FIG. 5, prior to configuring any overlay tunnel paths through the underlay of network 300, SDN controller 308 may first obtain the performance characteristics of the various links and paths available in the underlay network where SDN fabric 306 lives. As would be appreciated, an SDN controller, such as SDN controller 308, may typically use the Locator/ID Separation Protocol (LISP) to identify tunnel endpoints, to provision an overlay tunnel according to network policy. However, this does not take into consideration whether the new overlay tunnel will be capable of meeting the deterministic requirements of the traffic that it conveys.

Thus, before establishing the overlay tunnel path through the underlay, SDN controller 308 first needs to have a clear picture of the latency, bandwidth, and/or other performance characteristics of the underlay of network 300. To accomplish this, SDN controller 308 may leverage telemetry data collected from networking devices 302, to measure the performance characteristics of pairs of adjacent networking devices 302 and their links in the network (e.g., in terms of measured latency, bandwidth, jitter, etc.). This can be accomplished in a variety of ways. For instance, networking devices 302 in the underlay may send probes between each other, to measure the performance of their links 304. In other cases, this probing could be performed by leveraging the In-Situ Operations, Administration, and Maintenance (iOAM) protocol, which records OAM and telemetry information within data packets themselves, rather than having to rely on separate probes.

For instance, as shown, assume that the collected performance characteristics in network 300 are as follows, for certain links 304:
Link 304a between networking devices 302a-302b:
   Latency=0.5 ms
   Jitter=0.3 ms
   Bandwidth (BW)=8.4 Gbps
Link 304b between networking devices 302b-302c:
   Latency=0.8 ms
   Jitter=0.5 ms
   BW=7.2 Gbps
Link 304c between networking devices 302c-302d:
   Latency=0.5 ms
   Jitter=0.2 ms
   BW=5.7 Gbps
Link 304d between networking devices 302d-302e:
   Latency=0.5 Ms
   Jitter=0.4 ms
   BW=3.4 Gbps
etc.

Based on the deterministic requirements of the traffic associated with endpoint 310, SDN controller 308 may examine the network map of network 300 for possible paths, such as a primary and/or secondary path, that can satisfy the latency, jitter, bandwidth, etc. requirements of the traffic, based on the collected performance characteristics of networking devices 302 and links 304. Since the application may have a low tolerance to network problems, SDN controller 308 may choose links 304 that have a high degree of historical reliability (e.g., long-term predictable latency between hops, low recorded jitter, long-term bandwidth availability, etc.). In general, a goal of SDN controller 308 may be to not only find a path through the underlay of network 300 that meets the requirements of the traffic, but also to maximize the stability of that path in terms of its performance. Accordingly, SDN controller 308 may generate a sorted list of possible paths between endpoint 310 and endpoint 312, taking into account their abilities to satisfy the deterministic requirements of the traffic between them, their path stabilities, etc.

In some cases (e.g., when Segment Routing is used), SDN controller 308 may also identify alternative segments through the underlay of network 300 that may result in longer, but more deterministic networking-friendly paths. For instance, SDN controller 308 may select one path between endpoint 310 and endpoint 312 that offers slightly higher latency than that of an alternate path, but still satisfies the deterministic requirements of their traffic, if that path offers much greater stability in terms of its performance (e.g., the alternate path demonstrates transient spikes in its latency, etc.). The result of this may be for SDN controller 308 avoiding particular segments or areas of the network, or allowing more than one path between endpoint 310 and endpoint 312.

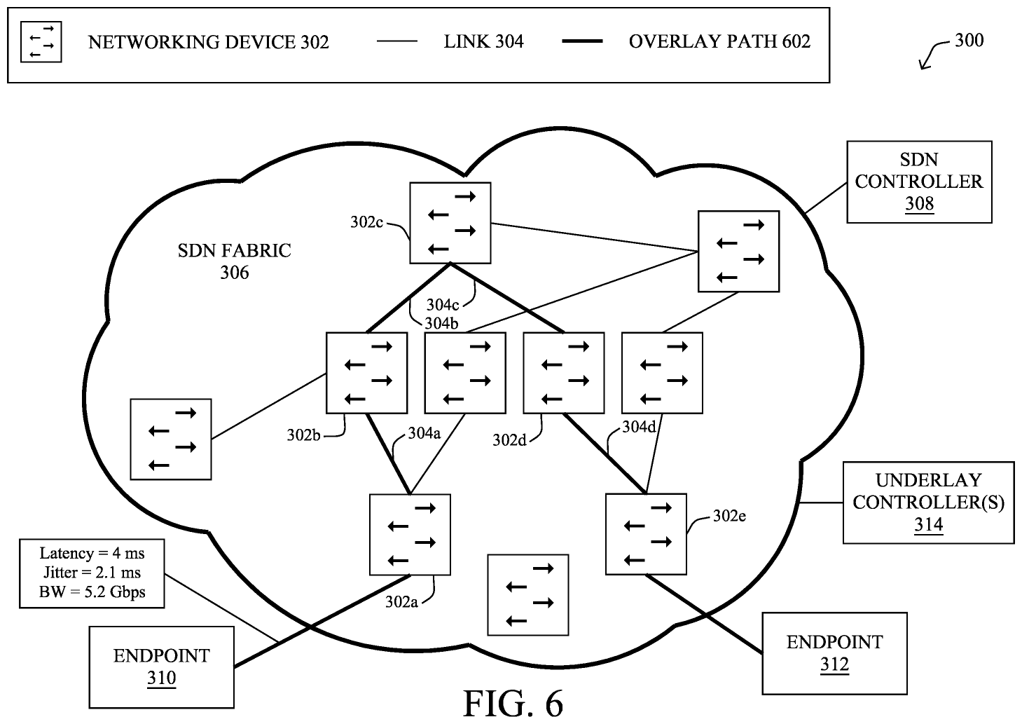

By examining the topology table for network 300 and calculating a path that meets the aggregate requirements, SDN controller 308 may engineer a path through the underlay. For instance, as shown in FIG. 6, SDN controller 308 may determine that overlay path 602 should be established between endpoint 310 and endpoint 312 in the overlay of SDN fabric 306.

In some embodiments, prior to actually transmitting traffic between endpoint 310 and endpoint 312 via overlay path 602, SDN controller 308 may further test overlay path 602 to ensure that it actually satisfies the deterministic requirements of the traffic associated with endpoint 310. Indeed, while overlay path 602 is predicted to satisfy these requirements, SDN controller 308 may further initiate testing of overlay path 602 to prove that this is the case. To this end, SDN controller 308 may use the edge routers involved networking device 302a and networking device 302e) to measure the end-to-end performance characteristics of overlay path 602. If overlay path 602 passes this testing, SDN controller 308 may then activate overlay path 602 for use to convey traffic between endpoint 310 and endpoint 312. As would be appreciated, the net effect of this is an overlay path is created that is predictable and able to satisfy the deterministic requirements of its traffic.

With respect to the underlay of network 300, the networking devices 302 associated with overlay path 602 will also be configured to correctly route traffic according to overlay path 602. To do so, in various embodiments, SDN controller 308 may associate a special marking with the traffic conveyed via overlay path 602. For instance, the marking may take the form of an identifier added to the VxLAN header at the edge of SDN fabric 306 at ingress (e.g., by networking device 302a) and removed at egress (e.g., by networking device 302e). Such an identifier may be, in some instances, a security group tag (SGT) or other identifier that is used to identify the overlay packet for special TSN/deterministic handling and specific path forwarding.

To engineer the path, SDN controller 308 may install a specific next-hop route on each underlay router that is based on the identifier. For example, if the SGT=1234, then the policy-based routing (PBR) decision would be to forward the packet along the engineered path (e.g., router 2015:abce:dabc:bace:1). In other words, SDN controller 308 may program an engineered path in the underlay associated with overlay path 602 using PBR and special SGTs through the underlay. Note that other forms of tagging could also be used, to identify the traffic to the underlay.

As a result of the above configurations, there are now two forwarding planes that need to be managed: the underlay forwarding plane and the overlay forwarding plane. In TSN networks, a CNC is typically used for scheduling forwarding on the routers/networking devices 302. In this case, a CNC or similar mechanism in underlay controller(s) 314 may be leveraged to create a consolidated definition and schedule for the underlay+overlay. The CNC then passes this configuration to SDN controller 308, which can then push it to all networking devices 302 associated with overlay path 602, both for the underlay and overlay forwarding planes. Unlike a traditional TSN scheduling controller, SDN controller 308 here is used to schedule packet forwarding on both the underlay as well as the tunnel overlay interfaces through a tight coordination of these two networks.

Similar to traditional TSN, scheduling now needs to happen at egress for every router associated with overlay path 602. However, in this case, it is the overlay packets that may be scheduled. By identifying the incoming packets according to their special indicators (e.g., an SGT or other tag that identifying them as the latency-sensitive application), the packets are then forwarded according to egress interface scheduling definition programmed into the routers by the SDN controller 308.

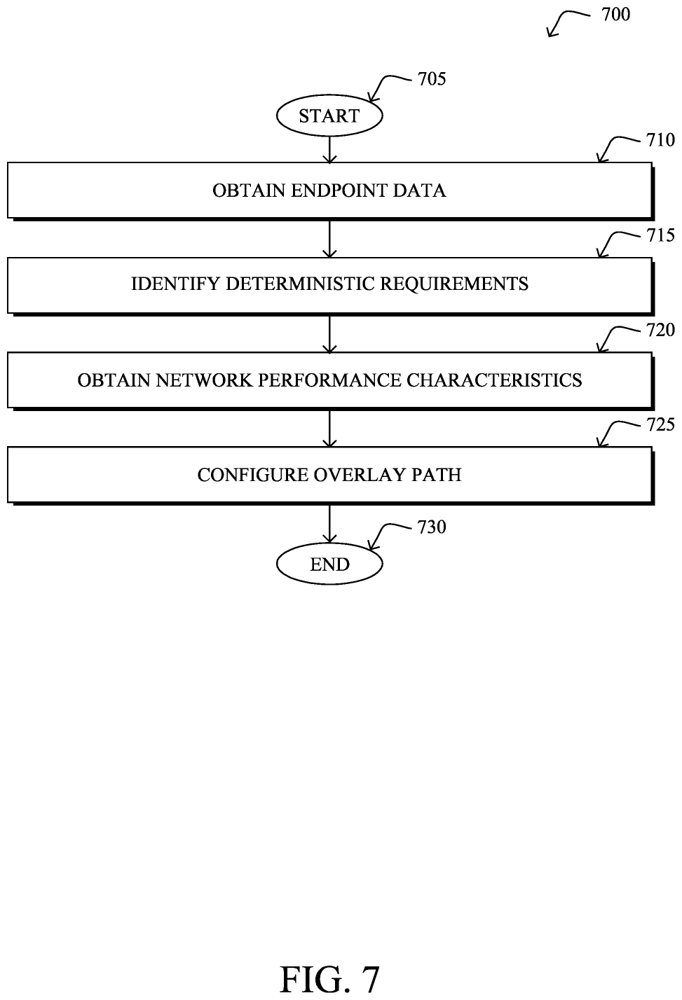

FIG. 7 illustrates an example simplified procedure for the coordination of the overlay and underlay of an SDN for deterministic traffic, in accordance with one or more embodiments described herein. The procedure 700 may start at step 705, and continues to step 710, where, as described in greater detail above, a specifically-configured device (e.g., device 200), such as an SDN controller, may obtain endpoint data regarding an endpoint in a network. In some embodiments, the SDN controller may obtain the endpoint data from a TSN CUC. In other embodiments, the SDN controller may receive a MUD URI sent by the URI and retrieve the endpoint data from a service associated with a manufacturer of the endpoint and located at the MUD URI.

At step 715, as detailed above, the SDN controller may identify any deterministic requirements of the endpoint, based on the endpoint data. In some instances, the deterministic requirements may be explicitly specified in the endpoint data. For instance, data from a TSN CUC may indicate the required path latency, jitter, bandwidth, etc. of the traffic associated with the endpoint. In other instances, the SDN controller may infer the deterministic requirements of the endpoint device, such as based on its device type or other information included in the endpoint data.

At step 720, the SDN controller may obtain performance characteristics of the network, as described in greater detail above. For instance, the SDN controller may obtain the measured latencies, bandwidths, jitter, etc., of the links in the network. This can be achieved either through specific probing or leveraging in-band telemetry, such as iOAM data.

At step 725, as detailed above, the SDN controller may configure, based on the performance characteristics of the network, an overlay path in the network connecting the endpoint to a destination that satisfies the deterministic requirements of the endpoint. In some embodiments, the SDN controller may do so by associating an identifier with the overlay path, whereby the endpoint includes the identifier in a header of traffic sent by the endpoint to the destination (e.g., a VxLAN header, etc.). This allows routers along the overlay path to use the identifier to send packets of the traffic according to a schedule associated with the identifier. For instance, the identifier may be an SGT or other identifier that can be used to signal that the traffic has deterministic requirements. In some embodiments, the SDN controller may instruct a networking device associated with the overlay path to make one or more performance measurements with respect to the overlay path and determine whether the one or more performance measurements satisfy the deterministic requirements of the endpoint, prior to allowing the endpoint to send traffic to the destination via the overlay path. In another embodiment, the SDN controller may identify a particular link or segment in the network to be avoided, based on its performance characteristics or reliability, and configure the overlay path to avoid that link or segment. Procedure 700 then ends at step 730.

It should be noted that while certain steps within procedure 700 may be optional as described above, the steps shown in FIG. 7 are merely examples for illustration, and certain other steps may be included or excluded as desired. Further, while a particular order of the steps is shown, this ordering is merely illustrative, and any suitable arrangement of the steps may be utilized without departing from the scope of the embodiments herein.

The techniques described herein, therefore, provide for the coordination between an overlay and underlay in an SDN network, to support determinism. In further embodiments, this coordination may be fully automated, to allow for ease of configuration, such as by establishing overlay tunnels, underlay forwarding schedules, etc.

While there have been shown and described illustrative embodiments for the coordination of the overlay and underlay of an SDN network, it is to be understood that various other adaptations and modifications may be made within the intent and scope of the embodiments herein. For example, while specific protocols are used herein for illustrative purposes, other protocols and protocol connectors could be used with the techniques herein, as desired. Further, while the techniques herein are described as being performed by certain locations within a network, the techniques herein could also be performed at other locations, such as at one or more locations fully within the local network (e.g., by the edge device), etc.

The foregoing description has been directed to specific embodiments. It will be apparent, however, that other variations and modifications may be made to the described embodiments, with the attainment of some or all of their advantages. For instance, it is expressly contemplated that the components and/or elements described herein can be implemented as software being stored on a tangible (non-transitory) computer-readable medium (e.g., disks/CDs/RAM/EEPROM/etc.) having program instructions executing on a computer, hardware, firmware, or a combination thereof. Accordingly, this description to be taken only by way of example and not to otherwise limit the scope of the embodiments herein. Therefore, it is the object of the appended claims to cover all such variations and modifications as come within the true intent and scope of the embodiments herein.

What is claimed is:

1. A method comprising:
obtaining, by a software-defined networking controller, endpoint data regarding an endpoint in a network;
identifying, by the software-defined networking controller based on the endpoint data, deterministic requirements of the endpoint;
obtaining, by the software-defined networking controller, performance characteristics of the network; and
configuring, by the software-defined networking controller and based on the performance characteristics of the network, an overlay path in the network connecting the endpoint to a destination that satisfies the deterministic requirements of the endpoint.

2. The method as in claim 1, wherein configuring the overlay path comprises:
associating an identifier with the overlay path, wherein the endpoint includes the identifier in a header of traffic sent by the endpoint to the destination.

3. The method as in claim 2, wherein routers along the overlay path use the identifier to send packets of the traffic according to a schedule associated with the identifier.

4. The method as in claim 2, wherein the identifier is associated with a network security group.

5. The method as in claim 2, wherein the header is a virtual extensible local area network (VxLAN) header.

6. The method as in claim 1, further comprising:
instructing a networking device associated with the overlay path to make one or more performance measurements with respect to the overlay path; and
determining whether the one or more performance measurements satisfy the deterministic requirements of the endpoint, prior to allowing the endpoint to send traffic to the destination via the overlay path.

7. The method as in claim 1, wherein the performance characteristics of the network indicate latencies or bandwidths of links in the network.

8. The method as in claim 1, wherein configuring the overlay path in the network comprises:
identifying a particular link in the network to be avoided, based on its performance characteristics; and
configuring the overlay path to avoid the particular link.

9. The method as in claim 1, wherein obtaining the endpoint data regarding the endpoint comprises:
receiving a Manufacturer Usage Description uniform resource identifier sent by the endpoint; and
retrieving the endpoint data from a service associated with a manufacturer of the endpoint and located at the Manufacturer Usage Description uniform resource identifier.

10. The method as in claim 1, wherein the network comprises a time sensitive networking (TSN) underlay and a software-defined networking overlay.

11. An apparatus, comprising:
one or more network interfaces;
a processor coupled to the one or more network interfaces and configured to execute one or more processes; and
a memory configured to store a process that is executable by the processor, the process when executed configured to:
obtain endpoint data regarding an endpoint in a network;
identify, based on the endpoint data, deterministic requirements of the endpoint;
obtain performance characteristics of the network; and
configure, based on the performance characteristics of the network, an overlay path in the network connecting the endpoint to a destination that satisfies the deterministic requirements of the endpoint.

12. The apparatus as in claim 11, wherein the apparatus configures the overlay path by:
associating an identifier with the overlay path, wherein the endpoint includes the identifier in a header of traffic sent by the endpoint to the destination.

13. The apparatus as in claim 12, wherein routers along the overlay path use the identifier to send packets of the traffic according to a schedule associated with the identifier.

14. The apparatus as in claim 12, wherein the identifier is associated with a network security group.

15. The apparatus as in claim 12, wherein the header is a virtual extensible local area network (VxLAN) header.

16. The apparatus as in claim 11, wherein the process when executed is further configured to:
instruct a networking device associated with the overlay path to make one or more performance measurements with respect to the overlay path; and
determine whether the one or more performance measurements satisfy the deterministic requirements of the endpoint, prior to allowing the endpoint to send traffic to the destination via the overlay path.

17. The apparatus as in claim 11, wherein the apparatus configures the overlay path in the network by:
identifying a particular link in the network to be avoided, based on its performance characteristics; and
configuring the overlay path to avoid the particular link.

18. The apparatus as in claim 11, wherein the apparatus obtains the endpoint data regarding the endpoint by:
receiving a Manufacturer Usage Description uniform resource identifier sent by the endpoint; and
retrieving the endpoint data from a service associated with a manufacturer of the endpoint and located at the Manufacturer Usage Description uniform resource identifier.

19. The apparatus as in claim 11, wherein the network comprises a time sensitive networking (TSN) underlay and a software-defined networking overlay, and wherein the apparatus comprises a software-defined networking controller.

20. A tangible, non-transitory, computer-readable medium storing program instructions that cause a device to execute a process comprising:
obtaining endpoint data regarding an endpoint in a network;
identifying, based on the endpoint data, deterministic requirements of the endpoint;
obtaining performance characteristics of the network; and
configuring, based on the performance characteristics of the network, an overlay path in the network connecting the endpoint to a destination that satisfies the deterministic requirements of the endpoint.
